(19) United States
(12) Patent Application Publication
(10) Pub. No.: US 2005/0180449 A1
(43) Pub. Date: Aug. 18, 2005

(54) Method and computer program for controlling radio resources, user equipment, radio network controller, and base station

(76) Inventors: Karri Ranta-Aho, Espoo (FI); Antti Toskala, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/833,301

(22) Filed: Apr. 28, 2004

(30) Foreign Application Priority Data
Feb. 16, 2004 (FI) 20040244

(51) Int. Cl. H04B 7/216

(52) U.S. Cl. 370/437

(57) ABSTRACT

A method, base station, user equipment, radio network controller, and computer program are provided. According to the invention, data packets are communicated from a base station to user equipment over a high speed downlink packet access connection including a high speed physical downlink shared channel for data packet transfer and a high speed dedicated physical control channel for uplink signalling. The high speed physical downlink shared channel is suspended in a plurality of predefined suspension time periods while maintaining the high speed downlink packet access connection in a standby state.

### FIELD

The invention relates to a method of controlling radio resources in a wireless telecommunications system, a radio network controller for controlling radio resources in a wireless telecommunications system, a computer program for controlling radio resources in a wireless telecommunications system, a user equipment of a wireless telecommunications system, and a base station of a wireless telecommunications system.

### BACKGROUND

High Speed Downlink Packet Access (HSDPA) is a packet-based data service in a WCDMA (Wideband Code Division Multiple Access) downlink with typical data transmission capacity from a few megabits per second to more than ten megabits per second.

An HSDPA connection includes a high speed physical downlink shared channel (HS-PDSCH) for data packet transfer and a high speed dedicated physical control channel (HS-DPCCH) for uplink signalling. The HS-PDSCH and the HS-DPCCH are implemented on top of WCDMA (Wideband Code Division Multiple Access) dedicated channels, such as the DPDCH (Dedicated Physical Data Channel) and the DPCCH (Dedicated Physical Control Channel), and thus share the shared radio resources, such as power resources, with the WCDMA dedicated channels. The sharing of the radio resources results in inflexibility in radio resource allocation to the HSDPA channels and the WCDMA dedicated channels. Therefore, improvements are needed for radio resource control in a wireless telecommunications system supporting an HSDPA operation.

### BRIEF DESCRIPTION OF THE INVENTION

An object of the invention is to provide an improved method, user equipment, base station, radio network controller, and computer program.

According to a first aspect of the invention, there is provided a method of controlling radio resources in a wireless telecommunications system, the method including: communicating data packets from a base station to user equipment over a high speed downlink packet access connection including a high speed physical downlink shared channel for data packet transfer and a high speed dedicated physical control channel for uplink signalling; and suspending the high speed downlink packet access connection in a plurality of predefined suspension time periods while maintaining the high speed downlink packet access connection in a standby state.

According to a second aspect of the invention, there is provided a method of controlling radio resources in a wireless telecommunications system, the method including: communicating data packets from a base station to user equipment over a high speed downlink packet access connection including a high speed physical downlink shared channel for data packet transfer and a high speed dedicated physical control channel for uplink signalling; and suspending the transmission of the high speed dedicated physical control channel in a plurality of predefined suspension time periods while maintaining the high speed dedicated physical control channel in a standby state.

According to a third aspect of the invention, there is provided a base station of a wireless telecommunications system, the base station including: a communicating unit for communicating data packets to user equipment over a high speed downlink packet access connection including a high speed physical downlink shared channel for data packet transfer and a high speed dedicated physical control channel for uplink signalling; and a connection suspending unit connected to the communicating unit, for suspending the high speed downlink packet access connection in a plurality of predefined suspension time periods while maintaining the high speed downlink packet access connection in a standby state.

According to a fourth aspect of the invention, there is provided user equipment of a wireless telecommunications system, the user equipment including: a communicating unit for communicating data packets from a base station over a high speed downlink packet access connection including a high speed physical downlink shared channel for data packet transfer and a high speed dedicated physical control channel for uplink signalling; and a connection suspending unit connected to the communicating unit, for suspending the high speed downlink packet access connection in a plurality of predefined suspension time periods while maintaining the high speed downlink packet access connection in a standby state.

According to a fifth aspect of the invention, there is provided user equipment of a wireless telecommunications system, the user equipment including: a communicating unit for communicating data packets from a base station over a high speed downlink packet access connection including a high speed physical downlink shared channel for data packet transfer and a high speed dedicated physical control channel for uplink signalling; and a connection suspending unit connected to the communicating unit, for suspending the transmission of the high speed dedicated physical control channel in a plurality of predefined suspension time periods while maintaining the high speed dedicated physical control channel in a standby state.

According to a sixth aspect of the invention, there is provided a radio network controller for controlling radio resources in a wireless telecommunications system where data packets are communicated from a base station to user equipment over a high speed downlink packet access connection including a high speed physical downlink shared channel for data packet transfer and a high speed dedicated physical control channel for uplink signalling, the radio network controller including a suspension control unit for controlling the suspension of the high speed downlink packet access connection in a plurality of predefined suspension time periods with suspension parameters while maintaining the high speed downlink packet access connection in a standby state, the suspension parameters characterizing temporal characteristics of a plurality of suspension time periods; and a signalling unit connected to the suspension control unit, for signalling the suspension parameters.

According to a seventh aspect of the invention, there is provided a radio network controller for controlling radio resources in a wireless telecommunications system where data packets are communicated from a base station to user equipment over a high speed downlink packet access connection including a high speed physical downlink shared channel for data packet transfer and a high speed dedicated physical control channel for uplink signalling, the radio network controller including a suspension control unit for controlling suspension of the transmission of the high speed dedicated physical control channel in a plurality of predefined suspension time periods with suspension parameters while maintaining the high speed dedicated physical control channel in a standby state, the suspension parameters characterizing temporal characteristics of a plurality of suspension time periods; and a signalling unit connected to the suspension control unit, for signalling the suspension parameters.

According to an eighth aspect of the invention, there is provided a computer program for controlling radio resources in a wireless telecommunications system, the computer program executing a computer process including: communicating data packets from a base station to user equipment over a high speed downlink packet access connection including a high speed physical downlink shared channel for data packet transfer and a high speed dedicated physical control channel for uplink signalling; and suspending the high speed downlink packet access connection in a plurality of predefined suspension time periods while maintaining the high speed downlink packet access connection in a standby state.

According to yet another aspect of the invention, there is provided a computer program for controlling radio resources in a wireless telecommunications system, the computer program executing a computer process communicating data packets from a base station to user equipment over a high speed downlink packet access connection including a high speed physical downlink shared channel for data packet transfer and a high speed dedicated physical control channel for uplink signalling; and suspending the transmission of the high speed dedicated physical control channel in a plurality of predefined suspension time periods while maintaining the high speed dedicated physical control channel in a standby state.

Preferred embodiments of the invention are described in the dependent claims.

The method, user equipment, base station, network controller and computer program of the invention provide several advantages. In a preferred embodiment of the invention, the flexibility of the radio resource allocation is increased, thus enabling an increase in the number of simultaneous high speed downlink packet access users served by a base station, the reuse of the base station resources, and the allocation of power resources for the WCDMA dedicated channels.

### LIST OF DRAWINGS

In the following, the invention will be described in greater detail with reference to the preferred embodiments and the accompanying drawings, in which

FIG. 1 shows an example of the structure of a wireless telecommunications system;

FIG. 2 illustrates the elements of an HSDPA connection;

FIG. 3 shows a time structure of an HSDPA connection;

FIG. 4 shows examples of the structure of a radio network controller, the structure of a base station, and the structure of user equipment;

FIG. 5A shows a first example of the methodology according to embodiments of the invention;

FIG. 5B shows a second example of the methodology according to embodiments of the invention;

FIG. 6 shows a third example of the methodology according to embodiments of the invention, and

FIG. 7 shows a fourth example of the methodology according to embodiments of the invention.

### DESCRIPTION OF EMBODIMENTS

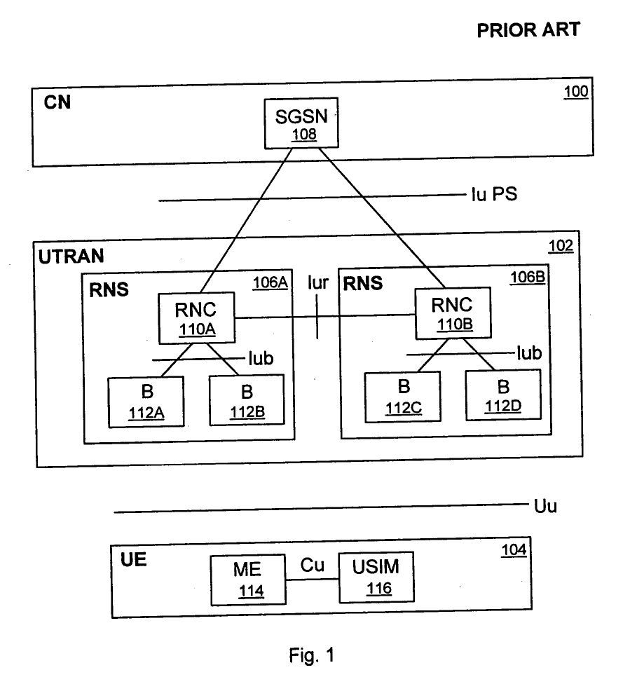

FIG. 1 illustrates an example of a wireless telecommunications system to which the present solution may be applied. Below, embodiments of the invention will be described using the UMTS (Universal Mobile Telecommunications System) as an example wireless telecommunications system. The structure and the functions of the network elements are only described when relevant to the invention.

The wireless telecommunications system may be divided into a core network (CN) 100, an UMTS terrestrial radio access network (UTRAN) 102, and user equipment (UE) 104. The core network 100 and the UTRAN 102 compose an infrastructure of the wireless telecommunications system.

The UTRAN 102 is typically implemented with wideband code division multiple access (WCDMA) radio access technology.

The core network 100 includes a serving GPRS support node (SGSN) 108 connected to the UTRAN 102 over an lu PS interface. The SGSN 108 represents the center point of the packet-switched domain of the core network 100. The main task of the SGSN 108 is to transmit packets to the user equipment 104 and to receive packets from the user equipment 104 by using the UTRAN 102. The SGSN 108 may contain subscriber and location information related to the user equipment 104.

The UTRAN 102 includes radio network sub-systems (RNS) 106A, 106B, each of which includes at least one radio network controller (RNC) 110A, 110B and nodes B 112A, 112B, 112C, 112D.

The radio network controller 110A, 110B controls the radio resources of the UTRAN 102. The radio network controller 110A, 110B controls one or more nodes B 112A, 112B, 112C, 112D. Functions performed by the radio network controller 110A, 110B include tasks such as downlink power control, handover management, and admission control. The radio network controllers 110A, 110B may communicate with each other through an lur interface.

Some functions of the radio network controller 110A, 110B may be implemented with a digital computer, memory and computer programs for executing computer processes. Furthermore, the radio network controller 110A, 110B may include connecting means, such as buses and cables, for connecting the radio network controller 110A, 110B to the node B 112A, 112B, 112C, 112D. The basic structure and the operation of the radio network controller 110A, 110B are known to one skilled in the art and only the details relevant to the presents solution are discussed in detail.

It should be noted, that the UTRAN 102 may also include IP (Internet Protocol) based network elements, such as IP base stations and IP servers. The structure of an IP radio access network is known to a one skilled in the art and the teachings of the present solution may easily be transferred from the given examples to the IP based systems.

The node B 112A, 112B, 112C, 112D implements the Uu interface, through which the user equipment 104 may access the telecommunications system infrastructure. The node B 112A, 112B, 112C, 112D performs tasks such as channel coding, rate adaptation, spreading, and basic radio resource management operations. Hereafter, the node B 112A, 112B, 112C, 112D is called a base station.

The base station 112A, 112B, 112C, 112D is further responsible for tasks associated with the HSDPA connection. Such tasks include scheduling the user equipment in the HSDPA data transfer, performing data packet retransmission procedures, such as HARQ (Hybrid Automatic Retransmission Request), and performing adaptive coding and modulation (AMC) procedures.

Some functions of the base station 112A, 112B, 112C, 112D may be implemented with a digital computer, memory and computer programs for executing computer processes. Furthermore, the base station 112A, 112B, 112C, 112D may include connecting means, such as buses and cables, for connecting the base station B 112A, 112B, 112C, 112D to the radio network controller 110A, 110B.

The basic structure and operation of the base station 112A, 112B, 112C, 112D are known to one skilled in the art and only the details relevant to the present solution are discussed in detail.

The user equipment 104 may include two parts: mobile equipment (ME) 114 and a UMTS subscriber identity module (USIM) 116.

The mobile equipment 114 typically includes at least one radio modem for implementing the Uu interface.

Some functionalities of the user equipment 104 may be implemented with a digital computer, memory and computer programs for executing computer processes. The user equipment 104 may further comprise an antenna, a user interface, and a battery.

The USIM 116 comprises user-related information and information related to information security in particular, for instance an encryption algorithm.

The basic structure and operation of the user equipment 104 are known to one skilled in the art and only the details relevant to the present solution are discussed in detail.

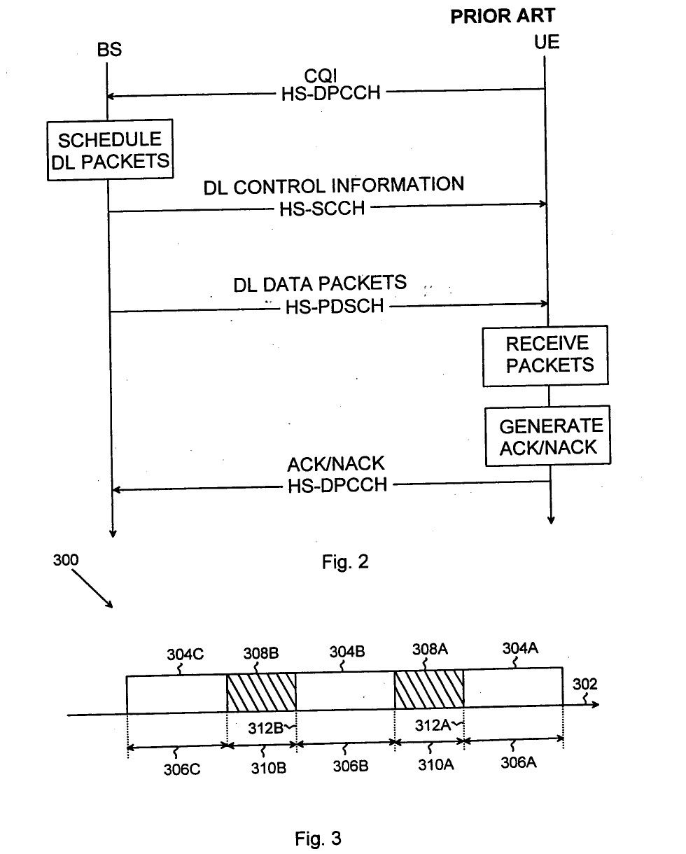

With reference to FIG. 2, an HSDPA (High Speed Downlink Packet Access) connection includes an HS-PDSCH (High Speed Physical Downlink Shared Channel), which provides a transport mechanism for HSDPA logical channels, such as an HS-DSCH (High Speed Downlink Shared Channel).

The HS-DSCH provides a logical transport mechanism for data transfer from the base station 112A to 112D to the user equipment 104. The HS-PDSCH may be both time- and code-shared between various pieces of user equipment 106 connected to the base station 112A to 112D.

The HSDPA connection further includes an HS-DPCCH (High Speed Dedicated Physical Control Channel), which is an uplink channel that carries packet acknowledgement messages (ACK/NACK) and channel information (CQI) on the HS-PDSCH. A packet acknowledgement message is typically generated for each data transport block received in the user equipment 104.

The packet acknowledgement messages (ACK/NACK) include an indication of the success or failure of reception of a data packet in the user equipment 104. The estimation of the success of the reception may be based on CRC (Cyclic Redundancy Check) carried out for a received packet in the user equipment 104. The packet acknowledgement messages are used for performing HARQ procedures in the base station 112A to 112D.

The channel information may be represented by a channel quality indicator (CQI), which characterizes the quality of the HS-PDSCH. The CQI is used as feedback information for AMC procedures. If the CQI information is outdated, scheduler decisions could be erroneous. An HSDPA connection typically includes an HS-SCCH (High Speed Physical Downlink Shared Control Channel), which serves as a downlink signalling channel parallel to the HS-PDSCH. The HS-SCCH carries downlink information such as channelization code sets, modulation scheme, transport block size, and HARQ process information to the user equipment 104. The downlink information allows the user equipment 104 to listen to the HS-DSCH at the correct time and to use the correct codes to allow successful decoding of a received packet.

The HSDPA connection is a communication connection including data transfer capabilities and signalling capabilities between the base station 112A to 112D and the user equipment 104. The HSDPA connection is formed on top of dedicated physical channels, such as DPDCH (Dedicated Physical Data Channel) and DPCCH (Dedicated Physical Control Channel) provided by the WCDMA radio access technology.

With reference to FIG. 3, a time structure 300 of an HSDPA connection is shown. The horizontal axis 302 shows time on an arbitrary scale. The timeline goes from the top to the bottom.

During a predefined suspension time period 308A, 308B, the HSDPA connection is suspended, i.e. the HS-DPSCH, HS-PDCCH, HS-SCCH, or a combination thereof, are not operable. However, during the suspension time periods 308A, 308B, the HSDPA connection remains in a standby state, i.e. the DPDCH and DPCCH are transmitted and received normally allowing the resumption of transmission of any of the HS-DPSCH, HS-PDCCH, or HS-SCCH without additional delays.

Between the suspension time periods 308A, 308B, there are operable HSDPA periods 304A, 304B, 304C, during which the HSDPA connection may be used for data packet transfer and signalling.

The temporal characteristics of the suspension time periods 308A, 308B may be characterized by suspension parameters. Such parameters are, for example, a suspension duration parameter which characterizes the duration 310A, 310B of the suspension time period 308A, 308B, frequency of occurrence of the suspension time periods 308A, 308B, and a suspension timing parameter which characterizes the timing 312A, 312B of the suspension time period 308A, 308B.

The timing 312A, 312B may correspond to the time instant when a suspension time period 308A, 308B starts.

The suspension parameters may further characterize the duration of the time periods 306A, 306B, 306C, when the suspension is off and the HSDPA connection is operable.

The suspension parameters may further represent the temporal characteristics of a sequence of the suspension time periods 308A, 308B. In such a case, the duration 310A, 310B of the different suspension time periods 3108A, 308B may be identical, and, thus, a single suspension duration parameter may be used to characterize the plurality of the suspension time periods 308A, 308B in the sequence. The use of the sequence of the suspension time periods 308A, 308b may be triggered and timed with a suspension timing parameter, which may characterize, for example, the timing 312A of the first suspension time period 308A in the sequence. The duration 310A, 310A of the suspension time period 308A, 308B may vary from 50 milliseconds to 500 milliseconds, while the duration 306A, 306B, 306C of the operable HSDPA periods 304A to 304C may vary from 50 milliseconds to 1000 milliseconds depending on the embodiment. The present solution is not, however, restricted to the above figures.

The predefined characteristics of the suspension time periods 308A, 308B and the standby state of the HSDPA connection are based on the fact, that at least a portion of the suspension parameters are available to the user equipment 104, base station 112A to 112D or both the user equipment 104 and base station 112A to 112D so that no signalling of the suspension parameters for example from the network controller 110A, 110B is required between the suspension time periods 308A, 308B. The suspension parameters may be programmed in the base station 112A to 112D and/or the user equipment in advance.

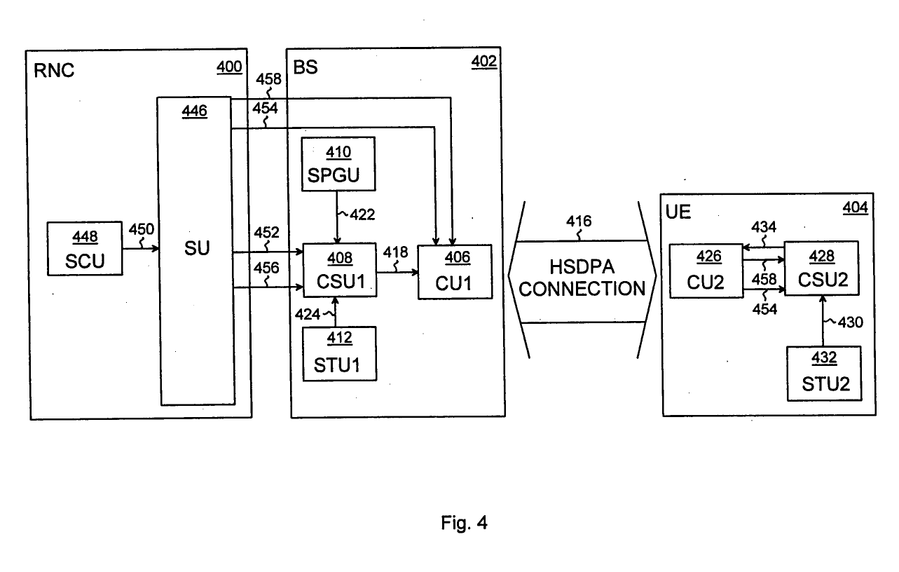

With reference to FIG. 4, the base station 402 includes a communicating unit (CU1) 406 for communicating data packets to the user equipment 404 over an HSDPA connection 416. The user equipment 404, correspondingly, includes a communicating unit (CU2) 426 for communicating data packets from the base station 402 over the HSDPA connection 416.

The communicating units 406, 426 provide the Uu interface and the implementation of the HSDPA channel structure including the HS-DPCCH, the HS-PDSCH, and the HS-SCCH. Furthermore, communicating units 406, 426 perform HSDPA communication procedures, such as the AMC procedures, HARQ procedures, and the associated signalling.

With further reference to FIG. 4, the radio network controller 400 includes a suspension control unit (SCU) 448 for controlling the suspension of the HSDPA connection 416 in a plurality of predefined suspension time periods 308A, 308B with suspension parameters 450 while maintaining the HSDPA connection 416 in a standby state.

The suspension parameters 450 are communicated to a signalling unit 446 which performs signalling of the suspension parameters 452, 454 to the base station 402.

The suspension control unit 448 may be implemented with a computer program which may be executed in the digital computer of the radio network controller 400.

In an embodiment of the invention, the suspension parameters 450 are generated in the suspension control unit 448 and delivered to the signalling unit 446.

The base station 402 may further include a suspension parameter generating unit (SPGU) 410 connected to a connection suspending unit 408. The suspension parameter generating unit 410 may generate suspension parameters 422 and deliver the suspension parameters 422 to the connection suspending unit 408.

The suspension parameter generating unit 410 of the base station 402 may be implemented with a digital computer and a computer program.

In an embodiment of the invention, suspension parameters 452, 454 are generated based on the number of user equipment sets 404 requiring an HSDPA connection 416 with the base station 402. As the number of the user equipment sets 404 requiring an HSDPA connection 416 increases, the capacity limit of the base station 402 may be exceeded. In such a case, some HSDPA connections 416 may be suspended, thus allowing the establishment of more HSDPA connections. As a result, the overall availability of the HSDPA service is improved.

In an embodiment of the invention, the suspension parameters 410, 452, 454 are generated based on an interference load in the uplink, which may result from excessive HS-DPCCH signalling. Such a case may occur, for example, if the uplink of a cell with HSDPA capability is already highly loaded due to active DPCCH and/or DPDCH of a great number of user equipment sets 404, and a great number of user equipment sets 404 transmit the HS-DPCCH simultaneously. Transmission of each HS-DPCCH requires its own share of the uplink capacity, thus adding to the overall load of the uplink.

In an embodiment of the invention, some of the user equipment sets 404 are located at the cell edge and a high transmit power is needed to provide a sufficient receive signal level in the base station 402. In order to enable successful uplink data transmission, e.g. user data transmission or RRC (Radio Resource Control) signalling, to the radio network controller 400, it may be beneficial to have sufficient transmit power available for the uplink DPCCH and/or DPDCH transmission. When the HS-DPCCH is being transmitted it requires a share of the transmission power resource available at the user equipment 404, thus reducing the possible transmission power available for the DPCCH and/or DPDCH. In a power limited situation, it is possible that if the HS-DPCCH is being transmitted, one or more uplink channels, DPCCH, DPDCH or HS-DPCCH, will be allocated sufficient power for reliable reception in the base station 402. Thus, by introducing time periods, such as the time period 308A, 308B, during which the HS-DPCCH is not transmitted in the uplink, the uplink DPCCH and/or DPDCH can be allocated an extensive amount of power. This, in turn, ensures that, for example, RRC signalling required by radio connection management has better probability of getting through even when the user equipment 404 is in a power limited situation.

The HSDPA connection 416 may be suspended in the user equipment 404, in the base station 402, or both in the user equipment 404 and the base station 402.

In an aspect of the invention, the user equipment 404 includes a connection suspending unit (CSU2) 428 for suspending the HSDPA connection 416 in the predefined suspension time periods 308A, 308B while maintaining the HSDPA connection 416 in a standby state.

The connection suspending unit 428 includes suspension parameters and transmits a control signal 434 to the communicating unit 426. The control signal 434 carries instructions for suspending the HSDPA connection 416 in the suspension time periods 308A, 308B.

The connection suspending unit 428 may be implemented, for example, with the digital computer and computer program of the user equipment 404.

In an aspect of the invention, the base station 402 includes a connection suspending unit (CSU1) 408 connected to the communicating unit 406, for suspending the HSDPA connection 416 in a plurality of predefined suspension time periods 308A, 308B while maintaining the HSDPA connection 416 in a standby state.

The connection suspending unit 408 includes suspension parameters and transmits a control signal 418 to the communicating unit 406. The control signal 418 carries instructions for suspending the HSDPA connection 416 in the suspension time periods 308A, 308B.

The connection suspending unit 408 may be implemented, for example, with the digital computer and computer program of the base station 402.

The suspension parameters may include instructions for suspending the HSDPA connection 416 in a synchronous manner in the user equipment 404 and base station 402. In such a case, both the user equipment 402 and the base station 402 may implement the suspending time periods, such as those shown in FIG. 3, in transmission/reception of the HSDPA connection 416.

A synchronization of the suspension procedures in the user equipment 404 and base station 402 may be based on, for example, general synchronization information required in radio transmission.

In an embodiment of the invention, the suspension parameters 454 are signalled to the communicating unit 406 of the base station 402, which delivers the suspension parameters 454 to the communicating unit 426 of the user equipment 404 by using a downlink channel such as the HS-SCCH of the HSDPA connection 416.

The communicating unit 426 of the user equipment 404 delivers the suspension parameters to the connection suspension unit 428 of the user equipment 404.

The suspension of the HSDPA connection 416 may be activated and possibly deactivated based on the suspension parameters 454.

In an embodiment of the invention, the suspension parameters 452 are signalled to the connection suspending unit 408 of the base station 402 by using NBAP (Node B Application Part) signalling, for example.

The suspension of the HSDPA connection 416 may be activated and possibly deactivated based on the suspension parameters 452.

In an embodiment of the invention, the user equipment 404 includes a storing unit (STU2) 432 connected to the connection suspending unit 428. The storing unit 432 stores suspension parameters 430, which may be used by the connection suspending unit 428 when the suspension of the HSDPA connection 416 is activated. The storing unit 432 may be implemented with memory means, such as random access memory.

In an embodiment of the invention, the base station 402 includes a storing unit (STU1) 412 connected to the connection suspending unit 408. The storing unit 412 stores suspension parameters 424, which may be used by the connection suspending unit 408 when the suspension of the HSDPA connection 416 is activated. The storing unit 412 may be implemented with memory means, such as random access memory.

The suspending control unit 448 of the radio network controller 400 may generate an activating signal 456, which is delivered to the connection suspending unit 408 of the base station 402. The activating signal 456 may explicitly activate the suspension of the HSDPA connection 416 or include instructions, such as timing, for starting the suspension. As a result of activation, the suspending unit 408 may retrieve the suspension parameters 424 from the storing unit 412.

The connection suspending unit 428 of the base station 402 receives an activating signal 452 and is activated to transmit a control signal 418 to the communicating unit 406 in order to suspend the HSDPA connection 416.

The suspending control unit 448 of the radio network controller 400 may also generate an activating signal 458, which is delivered to the connection suspending unit 428 of the user equipment 404 via a signalling channel, such as the HS-SCCH of the HSDPA connection 416. The activating signal 458 may explicitly activate the suspension of the HSDPA connection 416 or include instructions, such as timing, for starting the suspension. As a result of activation, the suspending unit 428 may retrieve the suspension parameters 430 from the storing unit 432.

The connection suspending unit 408 of the base station 402 receives an activating signal 458 and is activated to transmit a control signal 434 to the communicating unit 426 in order to suspend the HSDPA connection 416.

The storing unit 412, 432 and the activating signal 456, 458 enable suspension parameters 452, 454 to be delivered to the connection suspending unit 408, 428 prior to the execution of the actual suspension of the HSDPA connection, thus allowing flexibility in the timing of the signalling of the suspension parameters 452, 454. Furthermore, the suspension parameters 452, 454 may be used to perform the suspension of the HSDPA connection 416 for a long period of time, thus reducing the need to continuous deliver the suspending instruction to the connection suspending unit 408, 428.

The activating signal 456, 458 enables the suspension of the HSDPA connection 416 to be performed with the plurality of the suspension time periods 308A, 308B at a desired time instant, thus providing flexibility for selecting the time when the suspension of the HSDPA connection is executed.

The suspension of the HSDPA connection 416 may be implemented in various manners depending on the embodiment.

In an embodiment of the invention, the connection suspending unit 428 generates a control signal 434, which includes instructions for suspending the transmission of a CQI in uplink in a plurality of predefined suspension time periods 308A, 308B. The suspending of the transmission of the CQI may result in the use of an outdated CQI value in the scheduler. The use of the outdated CQI value may in some circumstances cause suspension or at least complications in scheduling the user equipment 102 and, thus, the suspension of transmission of the HS-DPSCH. In some applications, it would be beneficial to cancel the user equipment 404 from scheduling if the latest CQI available from the user equipment 404 in the base station scheduler was older than an implementation-specific time interval, which may be of the order of tens of milliseconds.

The suspension parameters 454 or the activating signal 458 signalled from the radio network controller 400 may include an instruction to remove the CQI from the frame structure of the HS-DPCCH signalled in the uplink. However, the transmission of the acknowledgement messages (ACK/NACK) may still be continued.

It should be noted that after each suspension time period 308A, 308B, the base station 402 would preferably continue transmitting the HS-DPSCH after the reception of a first reliable CQI in order to ensure a sufficient channel quality.

In an embodiment of the invention, the connection suspending unit 428 generates a control signal 434, which includes instructions for suspending the transmission of the HS-DPCCH in a plurality of predefined suspension time periods 308A, 308B.

The suspension parameters 454 or the activating signal 458 may include an instruction to cancel the transmission of the HS-DPCCH in the predefined suspension time periods 308A, 308B. The suspension of transmission of the HS-DPCCH may result in the lack of feedback information required for the AMC and HARQ, and the scheduler of the base station 402 may not be able to schedule the user equipment 404. As a result, transmission of downlink channels, such as the HS-PDSCH and the HS-SCCH, is interrupted approximately in the suspension time periods 308A, 308B.

The suspension of the HS-DPCCH releases radio resources for the DPCCH thus giving rise to cell coverage.

In an embodiment of the invention, the connection suspending unit 428 generates a control signal 434, which includes instructions for suspending reception of the HS-SCCH in a plurality of predefined suspension time periods 308A, 308B.

The suspension parameters 454 or the activating signal 458 signalled from the radio network controller 400 may include an instruction to cancel reception of the HS-SCCH in the predefined suspension time periods 308A, 308B. The suspension of reception of the HS-SCCH may be realized in the receiver of the user equipment 402 102 by interrupting the tracking of the HS-SCCH code channel and interrupting the processing of HS-SCCH data. The HS-SCCH informs the user equipment 402 if a data packet is to be received in one or several HS-PDSCH codes, and indicates data packet characteristics, such as those associated with modulation and coding, to enable the user equipment 402 to receive the data packet on the HS-PDSCH. As a result of suspending the reception of the HS-SCCH, the transmission of acknowledge messages is interrupted.

In some embodiments, the suspension of the HSDPA connection 416 is initiated in the base station 402.

In an embodiment of the invention, the connection suspending unit 408 of the base station 402 generates a control signal 418, which includes instructions for suspending the reception of the HS-DPCCH in a plurality of predefined suspension time periods 308A, 308B.

The suspension parameters 452 or the activating signal 456 signalled from the radio network controller 400 may include an instruction to cancel the reception of the HS-DPCCH in the predefined suspension time periods 308A, 308B.

The suspension of reception of the HS-DPCCH may result in the cancellation of the delivery of the CQI and acknowledgement messages to the base station 402 in approximately the suspension time periods 308A, 308B, and, thus in the incapability of transmitting the HS-PDSCH.

In an embodiment of the invention, the connection suspending unit 408 of the base station 402 generates a control signal 418, which includes instructions for suspending the scheduling of data packets to the user equipment 404 in a plurality of predefined suspension time periods 308A, 308B.

The suspension parameters 452 or the activating signal 456 signalled from the radio network controller 400 may include an instruction of cancelling the scheduling in the predefined suspension time periods 308A, 308B. As a result of suspending the scheduling, no data packets are received by the user equipment 402 and no acknowledgement messages are generated and transmitted.

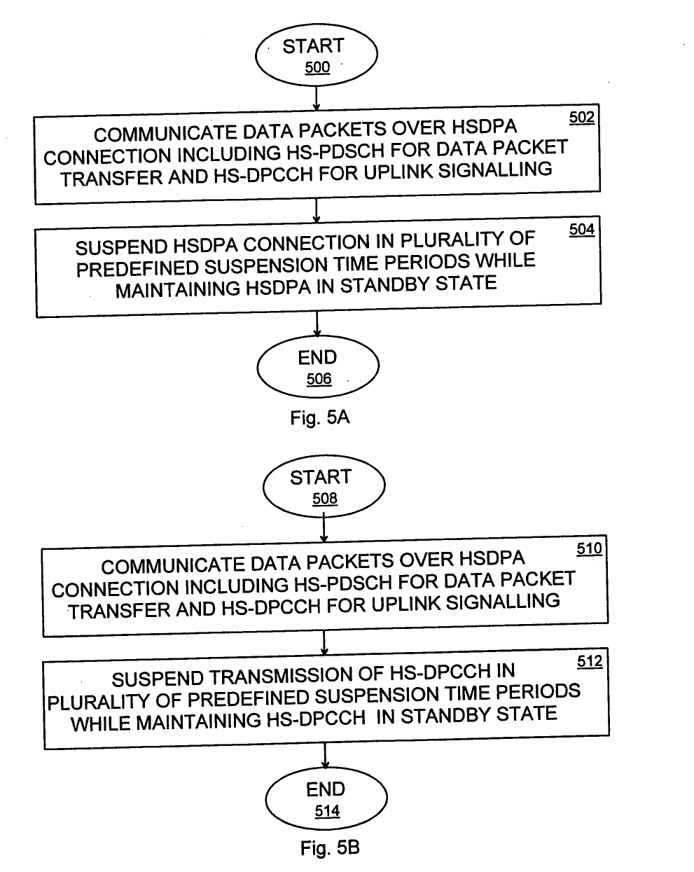

With reference to FIG. 5A, in an embodiment of the invention, the method starts in 500.

In 502, data packets are communicated over the HSDPA connection 416 including the HS-PDSCH and HS-DPCCH.

In 504, the HSDPA connection 416 is suspended in a plurality of predefined suspension time periods 308A, 308B while maintaining the HSDPA connection 416 in a standby state.

In 506, the method ends.

With reference to FIG. 5B, in an embodiment of the invention, the method starts in 508.

In 510, data packets are communicated over the HSDPA connection 416 including the HS-PDSCH and HS-DPCCH.

In 512, the transmission of the HS-DPCCH is suspended in the predefined time periods 308A, 308B while maintaining the HS-DPCCH in a standby state.

In 514, the method ends.

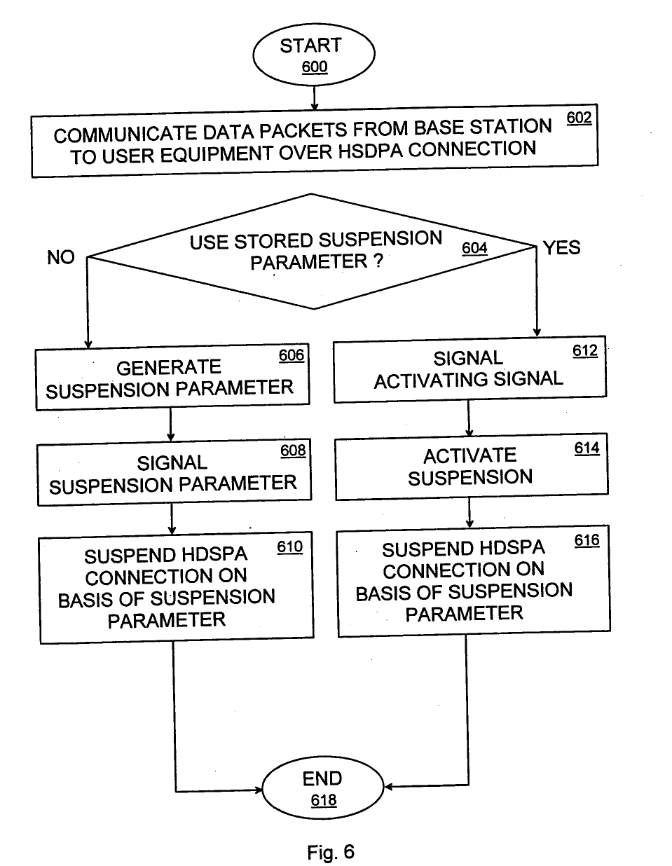

With reference to FIG. 6, in an embodiment of the invention, the method starts in 600.

In 602, data packets are communicated over the HSDPA connection 416 including the HS-PDSCH and HS-DPCCH.

In 604, a decision is made whether to use at least one stored suspension duration parameter 424, 430.

If the at least one stored suspension parameter 424, 430 is not used, at least one suspension parameter 452, 454 characterizing the temporal characteristics of the plurality of the suspension time periods 308A, 308B is signalled in 608, and the HSDPA connection 416 is suspended on the basis of the at least one suspension parameter in 610.

If the at least one stored suspension parameter 424, 430 is used, an activating signal 456, 458 is signalled in order to activate the suspension of the HSDPA connection 416 in 614. In 614, the suspension of the HSDPA connection 416 is activated. In 616, the HSDPA connection 416 is suspended in the plurality of time periods 308A, 308B on the basis of the at least one stored suspension parameter 452, 454.

In 618, the method ends.

With reference to FIG. 6, in an embodiment of the invention, the method starts in 700.

In 702, the data packets are communicated over the HSDPA connection 416 including the HS-PDSCH and HS-DPCCH.

In 704, the transmission of a channel quality indicator is suspended in uplink in a plurality of predefined suspension time periods 308A, 308B.

In 706, transmission of the HS-DPCCH is suspended in a plurality of predefined suspension time periods 308A, 308B while maintaining the HS-DPCCH in a standby state.

In 708, the reception of the HS-DPCCH is suspended in a plurality of predefined suspension time periods 308A, 308B while maintaining the HS-DPCCH in a standby state.

In 710, the scheduling of data packets to the user equipment is suspended in a plurality of predefined suspension time periods 308A, 308B.

In 712, the reception of the HS-SCCH is suspended in a plurality of predefined suspension time periods 308A, 308B while maintaining the HS-SCCH in a standby state.

In 714, the method ends.

The relative order of the method steps 704 to 712 may vary depending on the implementation. It is possible that the execution of one method step 704 to 712 triggers an execution of an other method step 704 to 712 due to the causalities of the different elements, such as channels and feedback information, applied in the HSDPA connection 416.

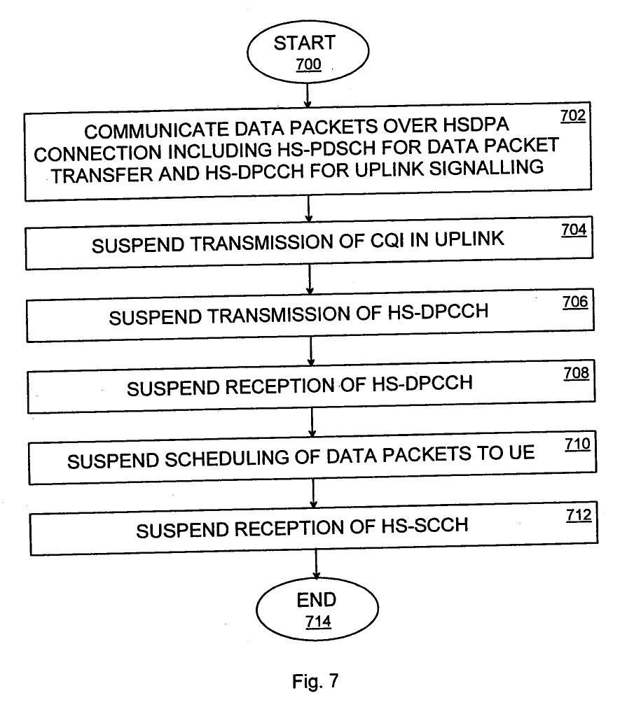

In some aspects, the invention provides a computer program for executing a computer process, of which embodiments are shown and described in conjunction with FIGS. 5A, 5B, 6, and 7.

The computer program may be implemented with a digital processor and memory means located in the radio network controller 400, base station 402, and the user equipment 404.

The computer program may be stored on a data carrier, such as a CD (Compact Disc), a hard drive, a diskette, and a portable memory unit. The computer program may further be transferred with an electric signal in a data network, such as the Internet.

Even though the invention has been described above with reference to an example according to the accompanying drawings, it is clear that the invention is not restricted thereto but can be modified in several ways within the scope of the appended claims.

1. A method of controlling radio resources in a wireless telecommunications system, the method comprising:
communicating data packets from a base station to user equipment over a high speed downlink packet access connection including a high speed physical downlink shared channel for data packet transfer and a high speed dedicated physical control channel for uplink signalling; and
suspending the high speed downlink packet access connection in a plurality of predefined suspension time periods while maintaining the high speed downlink packet access connection in a standby state.

2. A method of controlling radio resources in a wireless telecommunications system, the method comprising:
communicating data packets from a base station to user equipment over a high speed downlink packet access connection including a high speed physical downlink shared channel for data packet transfer and a high speed dedicated physical control channel for uplink signalling; and
suspending the transmission of the high speed dedicated physical control channel in a plurality of predefined suspension time periods while maintaining the high speed dedicated physical control channel in a standby state.

3. The method of claim 1, further comprising
suspending the transmission of the high speed dedicated physical control channel in a plurality of predefined suspension time periods while maintaining the high speed dedicated physical control channel in a standby state.

4. The method of claim 1, further comprising:
suspending the reception of the high speed dedicated physical control channel in a plurality of predefined suspension time periods while maintaining the high speed dedicated physical control channel in a standby state.

5. The method of claim 1, further comprising:
suspending the transmission of a channel quality indicator in uplink in a plurality of predefined suspension time periods, the channel quality indicator characterizing the quality of the high speed physical downlink shared channel.

6. The method of claim 1, further comprising:
suspending the scheduling of data packets to the user equipment in a plurality of predefined suspension time periods.

7. The method of claim 1, further comprising:
suspending the reception of the high speed physical downlink shared control channel in a plurality of predefined suspension time periods while maintaining the high speed physical downlink shared control channel in a standby state.

8. The method of claim 1, further comprising:
generating at least one suspension parameter characterizing temporal characteristics of a plurality of suspension time periods;
signalling the at least one suspension parameter; and
suspending the high speed downlink packet access connection in the plurality of time periods on the basis of the at least one suspension parameter.

9. The method of claim 1, further comprising:
storing at least one suspension parameter characterizing temporal characteristics of a plurality of suspension time periods;
signalling an activating signal in order to activate suspension of the high speed downlink packet access connection;
activating the suspension of the high speed downlink packet access connection; and
suspending the high speed downlink packet access connection in the plurality of time periods on the basis of the at least one suspension parameter.

10. A base station of a wireless telecommunications system, the base station comprising:
a communicating unit for communicating data packets to user equipment over a high speed downlink packet access connection including a high speed physical downlink shared channel for data packet transfer and a high speed dedicated physical control channel for uplink signalling; and
a connection suspending unit connected to the communicating unit, for suspending the high speed downlink packet access connection in a plurality of predefined suspension time periods while maintaining the high speed downlink packet access connection in a standby state.

11. The base station of claim 10, wherein the connection suspending unit is configured to suspend reception of the high speed dedicated physical control channel in a plurality of predefined suspension time periods while maintaining the high speed dedicated physical control channel in a standby state.

12. The base station of claim 10, wherein the connection suspending unit is configured to suspend scheduling of data packets to the user equipment in a plurality of predefined suspension time periods.

13. The base station of claim 10, wherein the base station further comprises a suspension parameter generating unit connected to the connection suspending unit, for generating at least one suspension parameter, the at least one suspension parameter characterizing temporal characteristics of a plurality of suspension time periods; and
wherein the connection suspending unit is configured to suspend the high speed downlink packet access connection in the plurality of time periods on the basis of the at least one suspension parameter.

14. The base station of claim 10, wherein the base station further comprises a storing unit connected to the connection suspending unit, for storing at least one suspension parameter characterizing the temporal characteristics of a plurality of suspension time periods; and
wherein the connection suspending unit is configured to be activated by a received activating signal and to suspend the high speed downlink packet access connection in the plurality of time periods on the basis of the at least one suspension parameter stored in the storing unit.

15. The base station of claim 10, wherein the connection suspending unit is configured to suspend the high speed downlink packet access connection on the basis of at least one suspension parameter received from a radio network controller, the at least one suspension parameter characterizing temporal characteristics of a plurality of suspension time periods.

16. User equipment of a wireless telecommunications system, the user equipment comprising:
a communicating unit for communicating data packets from a base station over a high speed downlink packet access connection including a high speed physical downlink shared channel for data packet transfer and a high speed dedicated physical control channel for uplink signalling; and
a connection suspending unit connected to the communicating unit, for suspending the high speed downlink packet access connection in a plurality of predefined suspension time periods while maintaining the high speed downlink packet access connection in a standby state.

17. User equipment of a wireless telecommunications system, the user equipment comprising:
a communicating unit for communicating data packets from a base station over a high speed downlink packet access connection including a high speed physical downlink shared channel for data packet transfer and a high speed dedicated physical control channel for uplink signalling; and
a connection suspending unit connected to the communicating unit, for suspending the transmission of the high speed dedicated physical control channel in a plurality of predefined suspension time periods while maintaining the high speed dedicated physical control channel in a standby state.

18. The user equipment of claim 16, wherein the connection suspending unit is configured to suspend the transmission of the high speed dedicated physical control channel in a plurality of predefined suspension time periods while maintaining the high speed dedicated physical control channel in a standby state.

19. The user equipment of claim 16, wherein the connection suspending unit is configured to suspend the transmission of a channel quality indicator in uplink in a plurality of predefined suspension time periods, the channel quality indicator characterizing the quality of the high speed physical downlink shared channel.

20. The user equipment of claim 16, wherein the connection suspending unit is configured to suspend the reception of the high speed physical downlink shared control channel in a plurality of predefined suspension time periods while maintaining the high speed physical downlink shared control channel in a standby state.

21. The user equipment of claim 16, wherein the communicating unit is configured to receive at least one suspension parameter, the at least one suspension parameter characterizing temporal characteristics of a plurality of suspension time periods; and
wherein the connection suspending unit is configured to suspend the high speed downlink packet access connection in the plurality of time periods on the basis of the at least one suspension parameter.

22. The user equipment of claim 16, wherein the user equipment further includes a storing unit connected to the connection suspending unit, for storing at least one suspension parameter characterizing the temporal characteristics of a plurality of suspension time periods; and
wherein the connection suspending unit is configured to be activated by a received activating signal and to suspend the high speed downlink packet access connection in the plurality of time periods on the basis of the at least one suspension parameter stored in the storing unit.

23. The user equipment of claim 16, wherein the connection suspending unit is configured to suspend the high speed downlink packet access connection on the basis of at least one suspension parameter received from a radio network controller.

24. A radio network controller for controlling radio resources in a wireless telecommunications system in which data packets are communicated from a base station to user equipment over a high speed downlink packet access connection including a high speed physical downlink shared channel for data packet transfer and a high speed dedicated physical control channel for uplink signalling, the radio network controller comprising:
a suspension control unit for controlling the suspension of the high speed downlink packet access connection in a plurality of predefined suspension time periods with suspension parameters while maintaining the high speed downlink packet access connection in a standby state, the suspension parameters characterizing temporal characteristics of a plurality of suspension time periods; and
a signalling unit connected to the suspension control unit, for signalling the suspension parameters.

25. A radio network controller for controlling radio resources in a wireless telecommunications system in which data packets are communicated from a base station to a user equipment over a high speed downlink packet access connection including a high speed physical downlink shared channel for data packet transfer and a high speed dedicated physical control channel for uplink signalling, the radio network controller comprising:

26. a suspension control unit for controlling the suspension of transmission of the high speed dedicated physical control channel in a plurality of predefined suspension time periods with suspension parameters while maintaining the high speed dedicated physical control channel in a standby state, the suspension parameters characterizing temporal characteristics of a plurality of suspension time periods; and
a signalling unit connected to the suspension control unit, for signalling the suspension parameters.

27. The radio network controller of claim 24, wherein the suspension control unit is configured to control the suspension of transmission of the high speed dedicated physical control channel in a plurality of predefined suspension time periods while maintaining the high speed dedicated physical control channel in a standby state.

28. The radio network controller of claim 24, wherein the suspension control unit is configured to control the suspension of reception of the high speed dedicated physical control channel in a plurality of predefined suspension time periods while maintaining the high speed dedicated physical control channel in a standby state.

29. The radio network controller of claim 24, wherein the suspension control unit is configured to control the suspension of transmission of a channel quality indicator in uplink in a plurality of predefined suspension time periods, the channel quality indicator characterizing the quality of the high speed physical downlink shared channel.

30. The radio network controller of claim 24, wherein the suspension control unit is configured to control the suspension of scheduling of data packets to the user equipment in a plurality of predefined suspension time periods.

31. The radio network controller of claim 24, wherein the suspension control unit is configured to control suspension of the reception of the high speed physical downlink shared control channel in a plurality of predefined suspension time periods while maintaining the high speed physical downlink shared control channel in a standby state.

32. The radio network controller of claim 24, wherein the suspension control unit is configured to generate at least one suspension parameter characterizing temporal characteristics of a plurality of suspension time periods.

33. The radio network controller of claim 24, wherein the suspension control unit is configured to generate an activating signal in order to activate the suspension of the high speed downlink packet access connection; and
wherein the signalling unit is configured to transmit the activating signal.

34. A computer program embodied on a computer readable medium, said computer program for controlling radio resources in a wireless telecommunications system, the computer program executing a computer process comprising:
communicating data packets from a base station to user equipment over a high speed downlink packet access connection including a high speed physical downlink shared channel for data packet transfer and a high speed dedicated physical control channel for uplink signalling; and
suspending the high speed downlink packet access connection in a plurality of predefined suspension time periods while maintaining the high speed downlink packet access connection in a standby state.

35. A computer program embodied on a computer medium, said computer program for controlling radio resources in a wireless telecommunications system, the computer program executing a computer process comprising:
communicating data packets from a base station to user equipment over a high speed downlink packet access connection including a high speed physical downlink shared channel for data packet transfer and a high speed dedicated physical control channel for uplink signalling; and
suspending the transmission of the high speed dedicated physical control channel in a plurality of predefined suspension time periods while maintaining the high speed dedicated physical control channel in a standby state.

36. The computer program of claim 33, wherein the computer process further comprises suspending the transmission of the high speed dedicated physical control channel in a plurality of predefined suspension time periods while maintaining the high speed dedicated physical control channel in a standby state.

37. The computer program of claim 33, wherein the computer process further comprises suspending the reception of the high speed dedicated physical control channel in a plurality of predefined suspension time periods while maintaining the high speed dedicated physical control channel in a standby state.

38. The computer program of claim 33, wherein the computer process further comprises suspending the transmission of a channel quality indicator in uplink in a plurality of predefined suspension time periods, the channel quality indicator characterizing the quality of the high speed physical downlink shared channel.

39. The computer program of claim 33, wherein the computer process further comprises suspending the scheduling of data packets to the user equipment in a plurality of predefined suspension time periods.

40. The computer program of claim 33, wherein the computer process further comprises suspending the reception of the high speed physical downlink shared control channel in a plurality of predefined suspension time periods while maintaining the high speed physical downlink shared control channel in a standby state.

41. The computer program of claim 33, wherein the computer process further comprises:
generating at least one suspension parameter characterizing temporal characteristics of a plurality of suspension time periods;
signalling the at least one suspension parameter; and
suspending the high speed downlink packet access connection in the plurality of time periods on the basis of the at least one suspension parameter.

42. The computer program of claim 33, wherein the computer process further comprises:
signalling an activating signal in order to activate the suspension of the high speed downlink packet access connection;
activating the suspension of the high speed downlink packet access connection; and
suspending the high speed downlink packet access connection in the plurality of time periods on the basis of the at least one suspension parameter.

43. A base station of a wireless telecommunications system, the base station comprising:
communication means for communicating data packets to user equipment over a high speed downlink packet access connection including a high speed physical downlink shared channel for data packet transfer and a high speed dedicated physical control channel for uplink signalling; and
suspending means connected to the communication means, for suspending the high speed downlink packet access connection in a plurality of predefined suspension time periods while maintaining the high speed downlink packet access connection in a standby state.

44. User equipment of a wireless telecommunications system, the user equipment comprising:
communication means for communicating data packets from a base station over a high speed downlink packet access connection including a high speed physical downlink shared channel for data packet transfer and a high speed dedicated physical control channel for uplink signalling; and
suspending means unit connected to the communication means, for suspending the high speed downlink packet access connection in a plurality of predefined suspension time periods while maintaining the high speed downlink packet access connection in a standby state.

45. User equipment of a wireless telecommunications system, the user equipment comprising:
communication means for communicating data packets from a base station over a high speed downlink packet access connection including a high speed physical downlink shared channel for data packet transfer and a high speed dedicated physical control channel for uplink signalling; and
suspending means connected to the communication means, for suspending the transmission of the high speed dedicated physical control channel in a plurality of predefined suspension time periods while maintaining the high speed dedicated physical control channel in a standby state.

46. A radio network controller for controlling radio resources in a wireless telecommunications system in which data packets are communicated from a base station to user equipment over a high speed downlink packet access connection including a high speed physical downlink shared channel for data packet transfer and a high speed dedicated physical control channel for uplink signalling, the radio network controller comprising:
controlling means for controlling the suspension of the high speed downlink packet access connection in a plurality of predefined suspension time periods with suspension parameters while maintaining the high speed downlink packet access connection in a standby state, the suspension parameters characterizing temporal characteristics of a plurality of suspension time periods; an
signalling means connected to the controlling means, for signalling the suspension parameters.

47. A wireless telecommunications system comprising:
communicating means for communicating data packets over a high speed downlink packet access connection comprising a high speed physical downlink shared channel for data packet transfer and a high speed dedicated physical control channel for uplink signalling; and
connection suspending means connected to the communicating means, for suspending the high speed downlink packet access connection in a plurality of predefined suspension time periods while maintaining the high speed downlink packet access connection in a standby state.

48. A wireless telecommunications system comprising:
communicating means for communicating data packets over a high speed downlink packet access connection including a high speed physical downlink shared channel for data packet transfer and a high speed dedicated physical control channel for uplink signalling; and
a connection suspending means connected to the communicating means, for suspending the transmission of the high speed dedicated physical control channel in a plurality of predefined suspension time periods while maintaining the high speed dedicated physical control channel in a standby state.
